(19) United States
(12) Patent Application Publication
(10) Pub. No.: US 2019/0383980 A1
(43) Pub. Date: Dec. 19, 2019

(54) DYNAMIC IMAGE DIFFRACTIVE DEVICE PRODUCT AND A METHOD OF MANUFACTURING THE SAME

(71) Applicant: SAINT SURPLUS INC., New Taipei City (TW)

(72) Inventors: Hsin-Chien LU, New Taipei City (TW); Hsien-Ming CHIU, New Taipei City (TW)

(21) Appl. No.: 16/012,102

(22) Filed: Jun. 19, 2018

(51) Int. Cl. G02B 5/18; G03B 21/20

(52) U.S. Cl. CPC G02B 5/1842; G03B 21/2033

(57) ABSTRACT

A dynamic image diffractive device product, including: a transparent substrate; and a hardened resin pattern layer adhered with a surface of the transparent substrate; wherein the hardened resin pattern layer has a plurality of grating pattern regions, so that when the transparent substrate is moved by a driving device to have each pattern region of the plurality of grating pattern regions illuminated in turn by a laser light source, a transmitted light beam from the transparent substrate will present a dynamic image on a surface of an external object.

### BACKGROUND OF THE INVENTION

### Field of the Invention

The present invention relates to an optical device product, and more particularly to a diffractive device product capable of providing a dynamic image and a method of manufacturing the same.

### Description of the Related Art

A typical laser projection device can only project a static image on a wall or a display screen, and its entertainment effect is limited.

To provide a dynamic image, the general practice is to replace a projected slide with a next slide within the time period of the persistence of vision. However, there will be discontinuities in the dynamic images produced in this way, so there is still room for improvement.

Therefore, a novel dynamic image projection scheme is urgently needed in the field.

### SUMMARY OF THE INVENTION

One objective of the present invention is to disclose a dynamic image diffractive device product capable of transmitting a diffracted light beam from a transparent substrate to a surface of an external object to present a dynamic image when a laser light source alternately illuminates a plurality of grating pattern regions of the dynamic image diffractive device product.

Another objective of the present invention is to disclose a method for manufacturing a dynamic image diffractive device, which can produce a dynamic image diffractive device product in a reliable and economical manner, and the dynamic image diffractive device product can transmit a diffracted light beam from a transparent substrate to a surface of an external object to present a dynamic image when a laser light source alternately illuminates a plurality of grating pattern regions of the dynamic image diffractive device product.

To attain the foregoing objectives, a dynamic image diffractive device product is proposed, including:

a transparent substrate; and

a hardened resin pattern layer adhered with a surface of the transparent substrate;

wherein the hardened resin pattern layer has a plurality of grating pattern regions, so that when the transparent substrate is moved by a driving device to have each pattern region of the plurality of grating pattern regions illuminated in turn by a laser light source, a transmitted light beam from the transparent substrate will present a dynamic image on a surface of an external object.

In one embodiment, the transparent substrate is a transparent plastic piece.

In one embodiment, the transparent substrate is of a square shape.

In one embodiment, the transparent substrate is in a form of a circular closed-loop belt.

In one embodiment, the transparent substrate is in a form of an elliptical closed-loop belt.

In one embodiment, the driving device includes a motor and at least one driving member driven by the motor.

In one embodiment, the driving device is configured to move the dynamic image diffractive device product along a straight line.

In one embodiment, the driving device is configured to move the dynamic image diffractive device product along a circular curve.

In one embodiment, the driving device is configured to move the dynamic image diffractive device product along an elliptical curve.

In one embodiment, the at least one driving member includes a reel and a retractable reel disposed respectively at two ends of the dynamic image diffractive device product.

To attain the foregoing objectives, the present invention further proposes a method for manufacturing the dynamic image diffractive device product, including steps of:

using a beam splitter to split a light beam output from a laser light source into a first light beam and a second light beam;

using an optical path delay unit to make the first light beam reach a photosensitive sheet on a movable platform after undergoing a first optical path, and performs an optical processing operation on the second light beam and causes the second light beam to undergo a second optical path before arriving at the photosensitive sheet on the movable platform, wherein the second optical path is approximately equal to the first optical path, and the optical processing operation includes: using a spatial filter and a first lens to filter out noise of the second light beam and form a parallel light beam, using a liquid crystal on-silicon device to reflect the parallel light beam, and using a lens combination to perform a Fourier optical conversion on a reflected light beam, where the liquid crystal on-silicon device outputs a dynamic image display, and the lens combination provides a Fourier optical conversion function;

using a movable platform to gradually move the photosensitive sheet to form a diffractive sheet having a surface carved with a plurality of first grating pattern regions by a combinational laser light beam;

fabricating a metal source product according to the diffractive sheet, wherein a surface of the metal source product has a plurality of second grating pattern regions, and the second grating pattern region is complementary to the first grating pattern region; and

applying a resin layer to the metal source product, attaching a transparent plastic member to a surface of the resin layer, and then irradiating UV light over the transparent plastic member to harden the resin layer, so that after removing the metal source product, the surface of the transparent plastic member will be formed with a hardened resin pattern layer having the plurality of first grating pattern regions.

In one embodiment, the liquid crystal on-silicon device outputs the dynamic image display according to a control of an image transmission device.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates a cross-sectional view of a dynamic image diffractive device product according to an embodiment of the present invention.

FIG. 2a illustrates an application example of the dynamic image diffractive device product of the present invention.

FIG. 2b illustrates another application example of the dynamic image diffractive device product of the present invention.

FIG. 2c illustrates another application example of the dynamic image diffractive device product of the present invention.

FIG. 2d illustrates still another application example of the dynamic image diffractive device product of the present invention.

FIG. 3 illustrates a manufacturing device for manufacturing the dynamic image diffractive device product.

FIG. 4 illustrates a flowchart of a method for manufacturing a dynamic image diffractive device product according to one embodiment of the present invention.

### DETAILED DESCRIPTION OF THE PREFERRED EMBODIMENTS

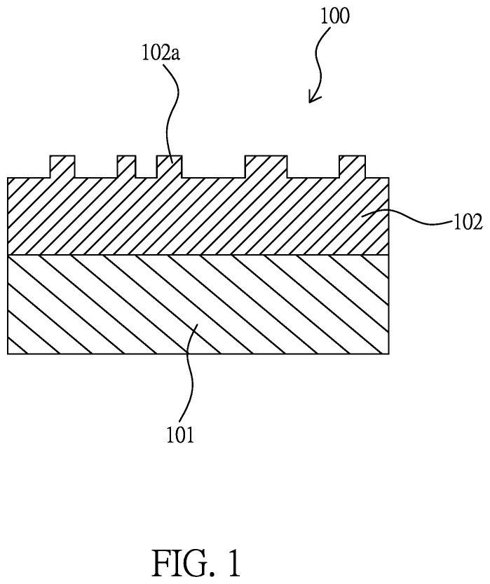

Please refer to FIG. 1, which illustrates a cross-sectional view of a dynamic image diffractive device product according to an embodiment of the present invention. As shown in FIG. 1, a dynamic image diffractive device product 100 has a transparent substrate 101 and a hardened resin pattern layer 102 adhered to a surface of the transparent substrate 101.

The transparent substrate 101 can be a transparent plastic piece. In possible embodiments, the transparent substrate 101 may be a square piece, a circular closed-loop belt, or an elliptical closed-loop belt.

The hardened resin pattern layer 102 has a plurality of grating pattern regions 102a. The transparent substrate 101 is to be moved by a driving device (not shown in FIG. 1) to let a laser light source (not shown in FIG. 1) alternately illuminate each region of the plurality of grating pattern regions 102a, and a resultant light beam emitted from the transparent substrate 101 will present a dynamic image on the surface of an external object. The external object can be for example but not limited to a wall or a projection screen.

The driving device may include a motor and at least one driving member driven by the motor to move the dynamic image diffractive device product 100 along a straight line, or along a circular curve or along an elliptical curve. In addition, in a possible embodiment, the at least one driving member includes one roll rod and one retractable roll element respectively disposed on the left and right ends of the dynamic image diffractive device product 100 to roll the dynamic image diffractive device product 100 to the left or to the right.

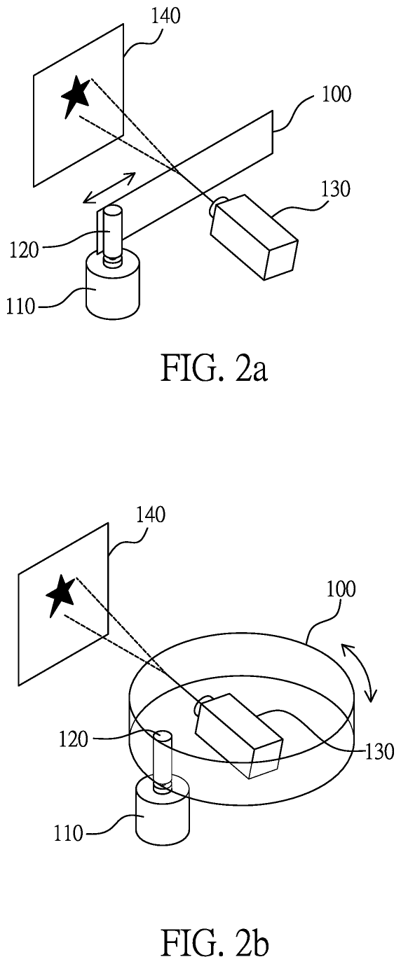

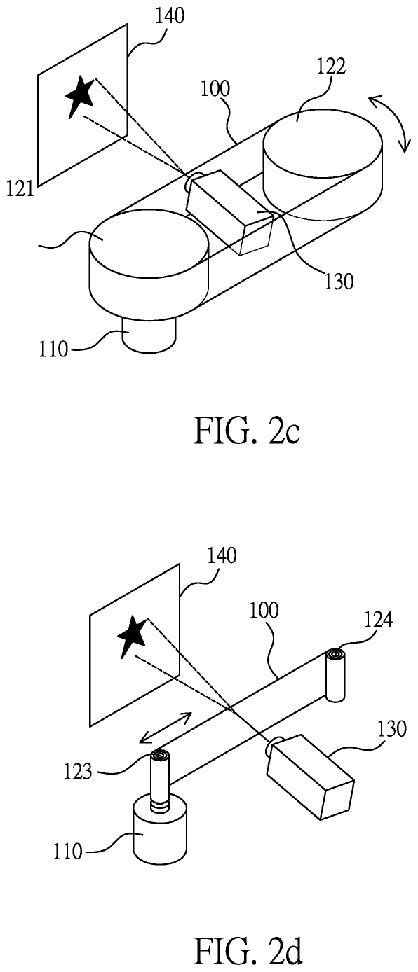

Please refer to FIG. 2a, which illustrates an application example of the dynamic image diffractive device product of the present invention. As shown in FIG. 2a, a motor 110 drives a dynamic image diffractive device product 100 through a driver 120 to periodically move the dynamic image diffractive device product 100 along a line, a laser light source 130 is fixed at one side of the dynamic image diffractive device product 100 to illuminate the dynamic image diffractive device product 100 at an oblique incidence angle, and a dynamic image is thereby present on the surface of an external object 140.

Please refer to FIG. 2b, which illustrates another application example of the dynamic image diffractive device product of the present invention. As shown in FIG. 2b, a motor 110 drives the dynamic image diffractive device product 100 through a driver 120 to periodically rotate the dynamic image diffractive device product 100 along a circular curve, a laser light source 130 is fixed at one side of the dynamic image diffractive device product 100 to illuminate the dynamic image diffractive device product 100 at an oblique incidence angle, and a dynamic image is thereby present on the surface of an external object 140.

Please refer to FIG. 2c, which illustrates another application example of the dynamic image diffractive device product of the present invention. As shown in FIG. 2c, a first roller bar 121 and a second roller bar 122 constitute a driving structure, and a motor 110 rotates the first roller bar 121 to drive the dynamic image diffractive device product 100 and the second roller bar 122, so that the dynamic image diffractive device product 100 periodically rotates along an elliptical curve, a laser light source 130 is fixed at one side of the dynamic image diffractive device product 100 to illuminate the dynamic image diffractive device product 100 at an oblique incidence angle, and a dynamic image is thereby present on the surface of an external object 140.

Please refer to FIG. 2d, which illustrates still another application example of the dynamic image diffractive device product of the present invention. As shown in FIG. 2d, a first roll bar 123 and a second roll bar 124 form a driving structure, where the second roll bar 124 is a retractable roll bar. A motor 110 rotates the first roll bar 123 to drive the dynamic image diffractive device product 100 and the second roll bar 124 to roll the dynamic image diffractive device product 100 to the left or to the right, a laser light source 130 is fixed at one side of the dynamic image diffractive device product 100 to illuminate the dynamic image diffractive device product 100 at an oblique incidence angle, and a dynamic image is thereby present on the surface of an external object 140.

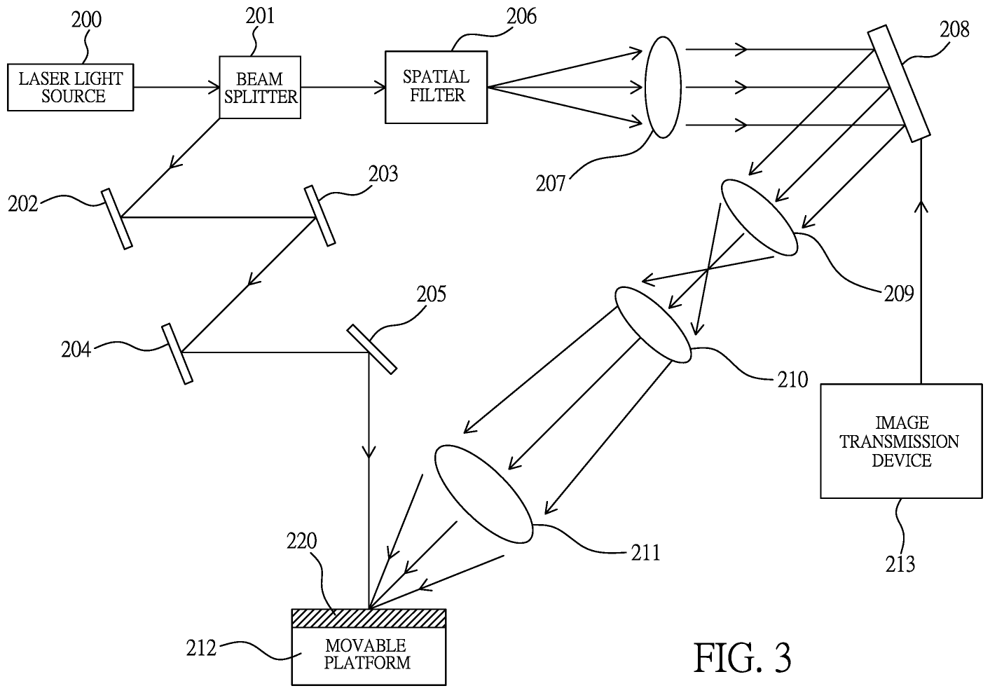

In addition, the present invention also proposes a manufacturing method of the dynamic image diffractive device product 100. Please refer to FIG. 3, which illustrates a manufacturing device for manufacturing the dynamic image diffractive device product 100. As shown in FIG. 3, the manufacturing device includes a laser light source 200, a beam splitter 201, a first reflector 202, a second reflector 203, a third reflector 204, a fourth reflector 205, a spatial filter 206, a first lens 207, a liquid crystal on silicon device 208, a second lens 209, a third lens 210, a fourth lens 211, a movable platform 212, and an image transmission device 213, wherein the first lens 207, the second lens 209, and the third lens 210 are designed to have a same size, and the fourth lens 211 is designed to have a larger size.

When in operation, the beam splitter 201 splits a light beam output from the laser light source 200 into a first light beam and a second light beam. The first light beam passes through the first reflector 202, the second reflector 203, the third reflector 204 and the fourth reflector 205 to reach a photosensitive sheet 220 on the movable platform 212, and the first light beam experiences a first optical path in total, that is, the first reflector 202, the second reflector 203, the third reflector 204, and the fourth reflector 205 are combined to act as an optical path delay unit; and the second light beam undergoes an optical processing procedure, including: the second light beam passes through the spatial filter 206 and the first lens 207 to filter out noise and form a parallel beam; and the parallel beam is first reflected by the liquid crystal on silicon device 208, and undergoes a Fourier optical conversion by passing through the second lens 209, the third lens 210, and the fourth lens 211, and then reaches the photosensitive sheet 220 on the movable platform 212. In the optical processing procedure, the second light beam experiences a second optical path in total, and the second optical path is approximately equal to the first optical path. In addition, the liquid crystal on silicon device 208 provides a dynamic display under the control of the image transmission device 213.

That is to say, the principle of the present invention lies in: (1) dividing a light beam output from a laser light source into a first light beam and a second light beam by a beam splitter; (2) adjusting the optical path of the first light beam to make the first light beam arrive at a photosensitive film at about the same time as the second light beam does after undergoing an optical operation process, wherein the optical operation process includes a filtering operation and a Fourier optical conversion operation; (3) the second light beam will possess an image frequency spectrum after undergoing the Fourier optical conversion operation, and the first light beam and the second light beam will interfere with each other at the photosensitive sheet to form a grating pattern on the surface of the photosensitive sheet.

In addition, the movable platform 212 will gradually move the photosensitive sheet 220 during operation, so that a surface of the photosensitive sheet 220 will be laser-engraved to form the plurality of first grating pattern regions, thereby generating a diffractive sheet.

Then, a metal source product is fabricated according to the diffractive sheet, wherein one surface of the metal source product has a plurality of second grating pattern regions, and the second grating pattern region is complementary to the first grating pattern region.

Then, the metal source product is coated with a resin layer, a transparent plastic member is attached to the resin layer, and UV (ultraviolet) light is used to illuminate the transparent plastic member to harden the resin. After the metal source product is removed, a hardened resin pattern layer will be formed on the transparent plastic member, and the hardened resin pattern layer will have the plurality of first grating pattern regions.

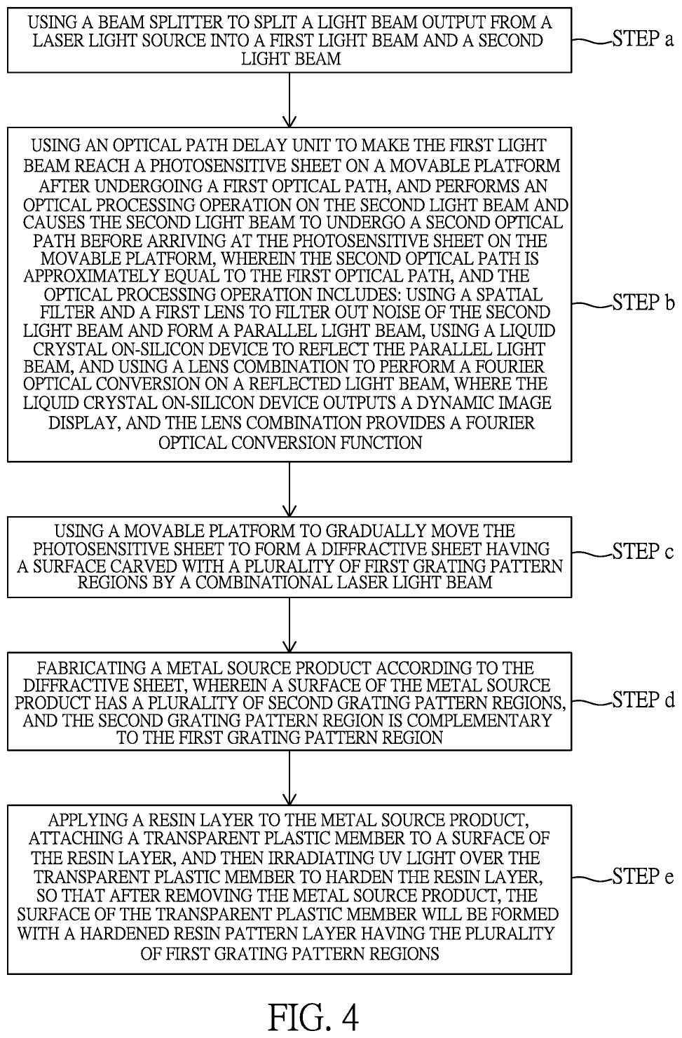

According to the description above, the present invention proposes a method of manufacturing a dynamic image diffractive device product. Please refer to FIG. 4, which illustrates a flowchart of a method for manufacturing a dynamic image diffractive device product according to one embodiment of the present invention. As shown in FIG. 4, the method includes the following steps: using a beam splitter to split a light beam output from a laser light source into a first light beam and a second light beam (step a); using an optical path delay unit to make the first light beam reach a photosensitive sheet on a movable platform after undergoing a first optical path, and performs an optical processing operation on the second light beam and causes the second light beam to undergo a second optical path before arriving at the photosensitive sheet on the movable platform, wherein the second optical path is approximately equal to the first optical path, and the optical processing operation includes: using a spatial filter and a first lens to filter out noise of the second light beam and form a parallel light beam, using a liquid crystal on-silicon device to reflect the parallel light beam, and using a lens combination to perform a Fourier optical conversion on a reflected light beam, where the liquid crystal on-silicon device outputs a dynamic image display, and the lens combination provides a Fourier optical conversion function (step b); using a movable platform to gradually move the photosensitive sheet to form a diffractive sheet having a surface carved with a plurality of first grating pattern regions by a combinational laser light beam (step c);

fabricating a metal source product according to the diffractive sheet, wherein a surface of the metal source product has a plurality of second grating pattern regions, and the second grating pattern region is complementary to the first grating pattern region (step d); and applying a resin layer to the metal source product, attaching a transparent plastic member to a surface of the resin layer, and then irradiating UV light over the transparent plastic member to harden the resin layer, so that after removing the metal source product, the surface of the transparent plastic member will be formed with a hardened resin pattern layer having the plurality of first grating pattern regions (step e).

Thanks to the designs mentioned above, the present invention can therefore provide a dynamic image diffractive device product in a reliable and economical manner, and the dynamic image diffractive device product, when its grating pattern regions are illuminated in turn by a laser light source, its transparent substrate will transmit a diffracted light beam to present a dynamic image on the surface of an external object, thereby providing an amazing and interesting entertainment effect.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A dynamic image diffractive device product, comprising:
a transparent substrate; and
a hardened resin pattern layer adhered with a surface of the transparent substrate;
wherein the hardened resin pattern layer has a plurality of grating pattern regions, so that when the transparent substrate is moved by a driving device to have each pattern region of the plurality of grating pattern regions illuminated in turn by a laser light source, a transmitted light beam from the transparent substrate will present a dynamic image on a surface of an external object.

2. The dynamic image diffractive device product as disclosed in claim 1, wherein the transparent substrate is a transparent plastic piece.

3. The dynamic image diffractive device product as disclosed in claim 2, wherein the transparent substrate is of a square shape.

4. The dynamic image diffractive device product as disclosed in claim 2, wherein the transparent substrate is in a form of a circular closed-loop belt.

5. The dynamic image diffractive device product as disclosed in claim 2, wherein the transparent substrate is in a form of an elliptical closed-loop belt.

6. The dynamic image diffractive device product as disclosed in claim 1, wherein the driving device includes a motor and at least one driving member driven by the motor.

7. The dynamic image diffractive device product as disclosed in claim 6, wherein the driving device is configured to move the dynamic image diffractive device product along a straight line.

8. The dynamic image diffractive device product as disclosed in claim 6, wherein the driving device is configured to move the dynamic image diffractive device product along a circular curve.

9. The dynamic image diffractive device product as disclosed in claim 6, wherein the driving device is configured to move the dynamic image diffractive device product along an elliptical curve.

10. The dynamic image diffractive device product as disclosed in claim 6, wherein the at least one driving member includes a reel and a retractable reel disposed respectively at two ends of the dynamic image diffractive device product.

11. A method for manufacturing the dynamic image diffractive device product, including steps of:
using a beam splitter to split a light beam output from a laser light source into a first light beam and a second light beam;
using an optical path delay unit to make the first light beam reach a photosensitive sheet on a movable platform after undergoing a first optical path, and performs an optical processing operation on the second light beam and causes the second light beam to undergo a second optical path before arriving at the photosensitive sheet on the movable platform, wherein the second optical path is approximately equal to the first optical path, and the optical processing operation includes: using a spatial filter and a first lens to filter out noise of the second light beam and form a parallel light beam, using a liquid crystal on-silicon device to reflect the parallel light beam, and using a lens combination to perform a Fourier optical conversion on a reflected light beam, where the liquid crystal on-silicon device outputs a dynamic image display, and the lens combination provides a Fourier optical conversion function;
using a movable platform to gradually move the photosensitive sheet to form a diffractive sheet having a surface carved with a plurality of first grating pattern regions by a combinational laser light beam;
fabricating a metal source product according to the diffractive sheet, wherein a surface of the metal source product has a plurality of second grating pattern regions, and the second grating pattern region is complementary to the first grating pattern region; and
applying a resin layer to the metal source product, attaching a transparent plastic member to a surface of the resin layer, and then irradiating UV light over the transparent plastic member to harden the resin layer, so that after removing the metal source product, the surface of the transparent plastic member will be formed with a hardened resin pattern layer having the plurality of first grating pattern regions.

12. The method for manufacturing the dynamic image diffractive device product as disclosed in claim 11, wherein the liquid crystal on-silicon device outputs the dynamic image display according to a control of an image transmission device.
